(19) United States
(12) Patent Application Publication
(10) Pub. No.: US 2025/0037198 A1
(43) Pub. Date: Jan. 30, 2025

(54) INVESTMENT COMPANY THAT DEFERS THE RECOGNITION OF DIVIDEND INCOME

(71) Applicant: Robert Hardy Newell, Highlands Ranch, CO (US)

(72) Inventor: Robert Hardy Newell, Highlands Ranch, CO (US)

(21) Appl. No.: 18/594,237

(22) Filed: Mar. 4, 2024

Related U.S. Application Data
(60) Provisional application No. 63/516,037, filed on Jul. 27, 2023.

(51) Int. Cl. G06Q 40/04

(52) U.S. Cl. CPC G06Q 40/04

(57) ABSTRACT

A method is provided for an investment company to defer the recognition of dividend income. A counterparty to the investment company makes an investment into the investment company, thereby becoming a shareholder. At the counterparty's demand, the counterparty's investment is redeemed in-kind using a security soon prior to its ex-dividend date. Subsequently, the counterparty may reinvest into the investment company using cash received from the security's dividend payment and the security soon following its ex-dividend date. The counterparty may be induced to invest in the investment company by the payment of fees earned by the investment company to the counterparty, by the payment of securities lending income earned by the investment company to the counterparty, or some combination of the two.

### BACKGROUND OF THE INVENTION

Investment companies are corporations or trusts that are in the business of buying and selling securities. Investment companies have previously patented methods resulting in the deferred recognition of capital gains income (US Patent '964). Starting in 2001, the Vanguard Total Stock Market Index Fund abruptly stopped showing capital gains, even as the fund went on to generate billions of dollars of them (Mider et al., May 2019). The first and largest ETF. State Street's SPDR S&P 500 ETF, hadn't reported a taxable gain in the 22 years through 2018 (Mider et al., March 2019).

Meanwhile, other investors have sought to convert dividend income to capital gains income by selling stocks soon prior to the stock's ex-dividend date (Cary. December 2011). This is because on the stock's ex-dividend date, the stock “breaks apart” into its cash dividend payment (or the right to receive that payment), and the residual security. The residual security can then be repurchased if desired by the investor. The repurchase price is essentially equal to the sales price less the dividend payment. +/−any short-term trading fluctuations in the security's price.

However, nothing in the prior indicates previous invention of a method to combine these two approaches; redeeming out a security in-kind soon prior to its ex-dividend date, and repurchasing it soon after its ex-dividend date. This is the novel method described below. This method enables an investment company to capture dividend income, but defer its recognition. This deferral is achieved by essentially converting dividend income into capital gains income, whose recognition is deferred by the redemption-in-kind mechanism permitted for investment companies under 26 U.S.C. § 852 (b) (6).

Deferring income recognition has a variety of benefits, including the deferred payment of taxes. However, there are other benefits as well. For example, a trustee may have dual commands to maximize trust principal, but distribute all recognized income to beneficiaries. By creating an investment company structured to defer all recognition of income-including capital gains and dividend income—the trustee is better positioned to achieve both of these non-tax objectives. Conversely, a trustee seeking greater recognition of income for a given underlying economic return may seek investment in this method's counterparty.

### BRIEF DESCRIPTION OF THE DRAWINGS

FIG. 1 shows a schematic diagram of an investment company receiving an investment from a counterparty. Soon prior to a security's ex-dividend date, the counterparty redeems its investment in the investment company. The redemption is met in-kind by the investment company, using the security soon prior to its ex-dividend date. The counterparty recognizes the dividend income, as the security “breaks apart” into its dividend and its residual value on the ex-dividend date (FIG. 2).

Soon following the ex-dividend date, the counterparty may reinvest in the investment company-possibly by using the cash received from the redeemed security's dividend, and the residual value of that security. The counterparty may be induced to invest in the investment company by the payment of fees earned by the investment company to the counterparty: by the payment of securities lending income earned by the investment company to the counterparty, or some combination of the two. Remaining income generated by the investment company may be directed to the owners/sponsors of the investment company, and/or to the investment company's underlying shareholders.

FIG. 2, shows the process by which a security's value is comprised of its anticipated dividend and its residual value prior to its ex-dividend date. On the ex-dividend date, the security “breaks apart” into its dividend (or the right to receive that dividend) and its residual value. On and following the ex-dividend date, the security's value is comprised solely of its residual value.

### BRIEF SUMMARY OF THE INVENTION

An investment company receives an investment from a counterparty. Soon prior to a security's ex-dividend date, the counterparty redeems its investment in the investment company. The redemption is met in-kind by the investment company, using the security soon prior to its ex-dividend date. The counterparty recognizes the dividend income, as the security “breaks apart” into its dividend and its residual value on the ex-dividend date.

Soon following the ex-dividend date, the counterparty may reinvest in the investment company-possibly by using the cash received from the redeemed security's dividend, and the residual value of that security. The counterparty may be induced to invest in the investment company by the payment of fees earned by the investment company to the counterparty, by the payment of securities lending income earned by the investment company to the counterparty, or some combination of the two. Remaining income generated by the investment company may be directed to the owners/sponsors of the investment company, and/or to the investment company's underlying shareholders.

### DETAILED DESCRIPTION OF THE INVENTION

An investment company is a corporation or trust that is in the business of buying and selling securities. Their structure and existence are regulated by the Investment Company Act of 1940. Investment companies are taxed under a special subchapter of the Internal Revenue Code, known as Subchapter M. One provision of Subchapter M. 26 U.S.C. § 852 (b) (6), allows investment companies to meet the demands of redeeming shareholders in-kind, using a security held by the investment company-rather than selling the security for cash, which is distributed to the redeeming shareholder. When a redemption is met in-kind in this way, no recognition of capital gains income occurs.

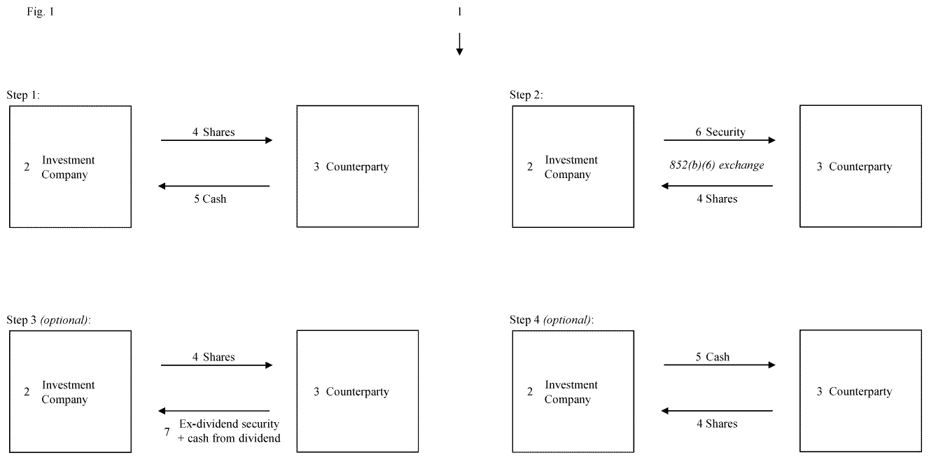

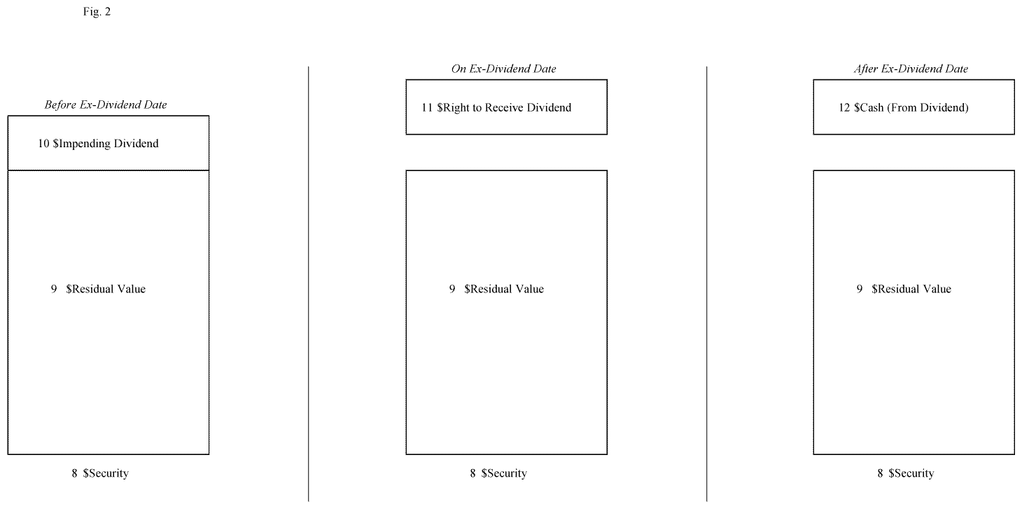

FIG. 1 is instructive. The (1) method or system described enables an (2) investment company to defer the recognition of dividend income, in addition to the deferred recognition of capital gains income which is documented in prior art. In Step 1, an (2) investment company receives an investment from a (3) counterparty. The (3) counterparty provides (5) cash to the (2) investment company, in exchange for (4) shares in the investment company. Consistent with industry practice, the number of (4) shares received by the (3) counterparty will be in the same proportion to the investment company's total shares as the (5) cash received by the (4) investment company to the (2) investment company's net asset value (NAV).

In Step 2, the same (2) investment company owns a (6) security that comprises part of the (2) investment company's NAV. Soon prior to the (6) security's ex-dividend date, the (3) counterparty demands to redeem its investment in the (2) investment company. The redemption is met in-kind by the (2) investment company: using the (6) security soon prior to its ex-dividend date and according to the mechanisms and requirements of 26 U.S.C. § 852 (b) (6). The (3) counterparty recognizes the dividend income, as the (6) security “breaks apart” into its dividend and its residual value on the ex-dividend date (see FIG. 2). This transaction is also completed at NAV: the (4) shares returned to the (2) investment company by the (3) counterparty will be in the same proportion to the (2) investment company's total shares as the (6) security's value to the (2) investment company's NAV. Note that the (2) investment company's NAV may fluctuate between Step 1 and Step 2. For purposes of calculating the (6) security's proportion of the (2) investment company's NAV, the (2) investment company and the (3) counterparty may agree to use the prevailing market price of the (6) security at the close of the trading day, or some other pricing method consistent with industry practice.

Step 3 is optional. Note that following Step 2, the (2) investment company and (3) counterparty are in approximately the same position as they were prior to Step 1 (although the NAV of the (2) investment company may have fluctuated in the meantime, so the cash value of the (3) counterparty's prior ownership stake may also have fluctuated). The (2) investment company could simply use the (5) cash provided by the (3) counterparty to repurchase the redeemed (6) security on or soon after its ex-dividend date. However. Step 3 provides for a closed loop system, in which the (3) counterparty reinvests into the (2) investment company using (7) the ex-dividend security and cash received from the security in exchange for (4) shares in the (2) investment company. If the dividend payment date remains in the future, the (3) counterparty may use other cash to reinvest into the (2) investment company. The advantage of using Step 3 is that if the (2) investment company and (3) counterparty are both looking to transact in the (7) ex-dividend security in the open market, both may experience adverse price impacts. But by exchanging the (7) ex-dividend security between themselves at prevailing market prices, no return leakage from adverse price impacts occurs. This transaction is also completed at NAV: the (4) shares issued to the (3) counterparty by the (4) investment company will be in the same proportion to the (2) investment company's total shares as the (7) ex-dividend security's value, plus any cash value, to the (2) investment company's NAV. For purposes of calculating the (7) ex-dividend security's proportion of the (2) investment company's NAV, the (2) investment company and the (3) counterparty may agree to use the prevailing market price of the (7) ex-dividend security at the close of the trading day: or some other pricing method consistent with industry practice.

Note that Step 3 is also optional because the (2) investment company may choose to make a new investment that is entirely different from the (6) security initially redeemed out in Step 2. In optional Step 3, the (7) ex-dividend security is the same underlying (6) security as in Step 2, albeit on or after the (6) security's ex-dividend date.

Note that the (5) cash and (7) ex-dividend security contemplated in Steps 1 and 3, respectively, could also be an entirely different contribution, such as a different security or asset with measurable value.

Step 4 is also optional. Following Step 3, the (3) counterparty may demand redemption from the (2) investment company, and receive (5) cash in exchange for the (3) counterparty's (4) shares. This transaction is also completed at NAV: the (4) shares returned to the (2) investment company by the (3) counterparty will be in the same proportion to the (2) investment company's total shares as the (5) cash's value to the (2) investment company's NAV. Note that the amount of (5) cash received by the (3) counterparty may be directionally similar to the amount of (5) cash originally injected by the (3) counterparty in Step 1, although not necessarily identical, because of the interim transactions in Step 2 and Step 3 and fluctuations in the (2) investment company's NAV. In addition, the (3) counterparty was exposed to fluctuations in the (6) security's price following redemption in Step 2, but before reinvestment of the (7) ex-dividend security in Step 3. The (2) investment company was not exposed to those fluctuations.

Step 4 is also optional because following Step 3, the (2) investment company and (3) counterparty are positioned to simply repeat Step 2 if desired.

In sum, the (2) investment company has captured the dividend return of the (6) security, because Step 2 occurred soon prior to the (6) security's ex-dividend date and therefore the value of the (6) security redeemed in Step 2 was inclusive of that dividend. And yet, the (2) investment company has recognized no dividend income, so long as the exchange in Step 2 obeys the strictures of 26 U.S.C. § 852 (b) (6).

FIG. 2 is instructive. In that figure, we see that a (8) security prior to its ex-dividend date has one value that is comprised of the (10) impending dividend and the (8) security's (9) residual value. On the ex-dividend date, the (8) security “breaks apart” into its (9) residual value and (11) the right to receive the dividend. This is because the actual payment date of the (11) dividend is usually sometime later. The (9) residual value of the security mechanically adjusts downward on market exchanges by the amount of the (11) dividend on the ex-dividend date, since the (8) security on that date no longer holds the right to receive the (11) dividend (Fidelity).

Technically: those who own the (8) security on the dividend's record date (not depicted) are entitled to the (11) dividend, while those who do not own the (8) security on the record date are not entitled to the (11) dividend. Therefore, one might expect the ex-dividend date to occur one business day after the record date. However, because trades ordinarily take two business days to settle, the ex-dividend date often occurs one business day before the record date (Fidelity). However, trade settlement practices may evolve in the future and this clarification is not meant to be a limitation on the described invention. Ultimately, the (11) right to receive the dividend converts into (12) cash when the dividend is actually paid.

While not depicted in FIG. 1, the (3) counterparty may be induced to invest in the (2) investment company by the payment of fees earned by the (2) investment company to the (3) counterparty, by the payment of securities lending income earned by the (2) investment company to the (3) counterparty, or some combination of the two. This is because the (3) counterparty is providing a valuable service to the (2) investment company by recognizing income which the (2) investment company seeks to avoid recognizing. The (3) counterparty may be comprised of non-taxable investors or other investors who seek, or are indifferent to, the recognition of dividend income. Remaining income generated by the (2) investment company may be directed to the owners/sponsors of the (2) investment company, and/or to the (2) investment company's underlying shareholders.

Any fees or securities lending income earned by the (2) investment company will hopefully be structured in a way that avoids income recognition for the underlying shareholders, since the (1) method endeavors to minimize the recognition of at least one type of income (dividend income). However, this clarification is not meant to be a limitation on the described invention.

The described (1) method is superior to other strategies which seek to avoid the recognition of dividend income, such as not owning dividend-paying securities. An active manager of an investment company may see dividend-paying securities as otherwise attractive, and chafe at the restriction of not owning them. A passive, or index-tracking, investment company may also chafe at not owning dividend-paying securities, since these securities may be in the investment company's underlying benchmark or index. Not owning them would create unacceptable tracking record risk for the passive investment company.

What is claimed is:

1. A method for an investment company to defer the recognition of dividend income, the method comprising:
a. an investment company which seeks to avoid the recognition of income;
b. a counterparty to the investment company which may be an authorized participant, another investment company, a fund of an alternative structure, or another entity that seeks or is neutral to the recognition of income;
c. an investment into the investment company by the counterparty, such that the counterparty is now a shareholder of the investment company;
d. a redemption demand by the counterparty, which will be met in-kind by the investment company using a dividend-paying security soon prior to its ex-dividend date according to the mechanisms and requirements of 26 U.S.C. § 852 (b) (6).

2. The method of claim 1 further comprising:
a. a re-investment by the counterparty into the investment company, comprised of cash received from the security's dividend and the security itself or, alternatively, cash or, alternatively, some other security or, alternatively, some combination of the three.

3. The method of claim 2 further comprising:
a. a redemption demand by the counterparty, which may be met in cash or, alternatively, in-kind by the investment company as described in part (d) of claim 1 or, alternatively, some combination of the two.

4. The methods of claim 1, and/or claim 2, and/or claim 3 further comprising:
a. a contractual arrangement between the investment company and the counterparty, such that securities lending income or fees earned by the investment company are directed to the counterparty in order to induce the counterparty's investment into the investment company.
